(19) United States
(12) Patent Application Publication
(10) Pub. No.: US 2024/0179167 A1
(43) Pub. Date: May 30, 2024

(54) AUTONOMOUS ANOMALOUS DEVICE OPERATION DETECTION

(71) Applicant: Sony Interactive Entertainment Europe Limited, London (GB)

(72) Inventors: Alan Suganuma MURPHY, London (GB); Pierluigi Vito AMADORI, London (GB)

(73) Assignee: Sony Interactive Entertainment Europe Limited, London (GB)

(21) Appl. No.: 18/511,365

(22) Filed: Nov. 16, 2023

(30) Foreign Application Priority Data
Nov. 25, 2022 (GB) 2217692.9

(51) Int. Cl. H04L 9/40; G06N 3/08

(52) U.S. Cl. CPC H04L 63/1425; G06N 3/08

(57) ABSTRACT

A computer implemented method for autonomous anomalous device behaviour detection. Including receiving behaviour data, wherein the behaviour data is indicative of a user's inputs to an electronic device. A behaviour pattern label and an indication to the likelihood of an anomaly occurring are determined based on the received behaviour data, wherein the behaviour pattern label belongs to behaviour pattern label hierarchy.

### CROSS-REFERENCE TO RELATED APPLICATIONS

The present application claims priority from British Patent Application No. 2217692.9 filed Nov. 25, 2022, the contents of which are incorporated herein by reference in its entirety.

### FIELD

The present disclosure relates to methods and systems for detection of anomalous operation of electronic devices. More particularity, the present disclosure provides methods to detect disallowed hardware or software modification of an electronic device and/or accessories thereof.

### BACKGROUND

Ensuring correct operation of electronic devices is critical for nearly every application. This similarly applies to the software running on electronic devices. This is also true where the electronic devices are end user owned and operated and further potentially allow other plugins (software or hardware) to be installed/used on the electronic device. In some cases, end users of the electronic device modify the device in non-allowed ways enabling untested or unwanted features that the electronic device manufacturer (or the developers of software running on the electronic device) did not intend.

Anomalous electronic device operation can be caused by many reasons. These could include foreign and/or uncertified peripheral devices interacting with the electronic device, foreign and/or uncertified software operating on the electronic device, and foreign and/or uncertified hardware modifications to the electronic device. These reasons can be intentionally or unintentionally introduced by the user. For example, an end user might unknowingly purchase a counterfeit peripheral device that results in anomalous operation of the electronic device in question. In such cases, the end user would not even know they were placing the electronic device into untested or unwanted modes of operation.

Such anomalous behaviour can result in many negative effects. Negative effects may include damage to the electronic device, placing the electronic device in untested execution/operation states, and unfair advantages of users of the electronic device if in a competitive situation with other's using the same or similar electronic device.

Detection of anomalies poses a challenge to electronic device designers. This is particularly true where the detector does not directly possess the hardware to inspect (visually or otherwise) how each electronic device is being used. In some situations, only observation of inputs and outputs of the electronic device are possible.

Given the negative outcomes of anomalous device operation, it can be seen that ensuring correct operation is desirable. Detection of anomalous operation is a first step in ensuring correct operation of the electronic device occurs.

Aspects and embodiments were conceived with the foregoing in mind.

### SUMMARY OF THE INVENTION

According to a first embodiment of a first aspect, there is provided a computer implemented method for autonomous anomaly device operation detection, the method comprising the steps receiving behaviour data, wherein the behaviour data is indicative of a user's inputs to an electronic device, determining a behaviour pattern label and an indication to the likelihood of an anomaly occurring based on the received behaviour data, wherein the behaviour pattern label belongs to behaviour pattern label hierarchy, providing the behaviour pattern label and the likelihood of an anomaly occurring.

Advantageously, providing a hierarchical behaviour pattern label in coordination with a likelihood of anomaly occurring, certain behaviours which might normally appear to be normal behaviour at one hierarchical level but not on another are more easily identified. Easier identification here relates to the processing steps in obtaining these outputs and thus enables more efficient data processing. Thus, a technical understanding of the operation of the electronic device is achieved through use of only input data.

Optionally, determining the behaviour pattern label and the indication to the likelihood of an anomaly occurring comprises processing the behaviour data using a behaviour machine learning model, wherein the behaviour pattern label is based on the output of the behaviour machine learning model. Preferably the behaviour machine learning model is a behaviour artificial neural network. Preferably the behaviour artificial neural network is a recurrent neural network.

Advantageously, use of machine learning and neural networks enables the federated learning as discussed below as well as improved pattern recognition which may not initially be apparent to developers of a traditional, non-machine learning based system. Additionally, the use of machine learning and artificial neural networks enables pattern recognition to be identified in ways that a traditional developer might not initially be aware of. Additionally, the use of machine learning and artificial neural networks enables flexible continuous learning to occur through use of updating models in an unsupervised manner and/or updating models in a federated manner.

Preferably the method further comprises the step of receiving user perspective data, wherein the user perspective data is indicative of a visual component of a scene being displayed by the electronic device, and wherein the step of determining the behaviour pattern label comprises and the indication to the likelihood of an anomaly occurring further comprises processing the user perspective data using a user perspective machine learning model, and wherein the behaviour pattern label and the indication to the likelihood of an anomaly occurring are additionally based on the output of the user perspective machine learning model. Preferably the user perspective machine learning model is a user perspective artificial neural network. Preferably the user perspective artificial neural network is a convolutional neural network.

Advantageously, the use of user perspective data enables extra information for anomalous device operation to be identified with. In particular, analysis using both the user's input (via the behaviour data) in coordination with the scene the user is seeing (i.e. the device output) allows for more accurate and specific analysis to be conducted which is based on an understand of how the user is actually interacting with the electronic device. Thus input patterns that are not based on the device output (for example by moving the cursor towards a model which is not actually in view) can be identified and this behaviour is likely indicative of the electronic device operating anomalously. Convolutional neural networks provide specific advantages in relation to processing visual information including feature recognition of the associated visual information.

Optionally, the step of determining the behaviour pattern label comprises and the indication to the likelihood of an anomaly occurring further comprises conducting data fusion based on the output of the user perspective machine learning model and the output of the behaviour machine learning model. Preferably, the data fusion step correlates the based on the output of the user perspective machine learning model and the output of the behaviour machine learning model with respect to time. Preferably, the data fusion step comprises providing the output of the user perspective artificial neural network and the output of the behaviour artificial neural network as inputs to a data fusion artificial neural network.

Preferably, step of determining a behaviour pattern label and an indication to the likelihood of an anomaly occurring based on the received behaviour data comprises the use of a prediction machine learning model. Preferably, the prediction machine learning model is an artificial neural network. More preferably, the prediction machine learning model is a Multilayer Perceptron. More preferably still, the prediction machine learning model is a multiheaded hierarchical prediction model.

Advantageously, data fusion enables deeper across a larger range of inputs input data and thus more accurate output data is achieved. Further advantageously using a prediction machine learning model similarly allows for deeper and more accurate prediction and analysis of the received data. The use specifically of a Multilayer Perceptron enables the ability for the machine learning system to infer information about complex non-linear systems. Further, the relative simplicity of a Multilayer Perceptron allows for high throughput and thus providing quicker, less CPU intensive predictions.

Optionally the method comprises the step of receiving scene audio data, wherein the scene audio data is indicative of audio being played in a scene being presented by the electronic device, and wherein the step of determining the behaviour pattern label comprises and the indication to the likelihood of an anomaly occurring further comprises processing the scene audio data using a scene audio machine learning model, and wherein the behaviour pattern label and the indication to the likelihood of an anomaly occurring are additionally based on the output of scene audio machine learning model. Preferably, the received scene audio data is processed to produce a time-frequency representation of the audio. Preferably, the received scene audio data is normalised. Preferably, the scene audio artificial neural network is a convolutional neural network. Preferably, the scene audio machine learning model is an artificial neural network. More preferably, the scene audio artificial neural network is a convolutional neural network.

Similar to the advantages of the user perspective, scene audio data provides more insight and information as to how the user is actually interacting and responding to the electronic device. Normalisation of the audio data provides a more useful input to the neural networks as the neural networks tend to converge faster and more stably with normalised data. Time-frequency representations, and specifically spectrograms, of audio are particularly suited to convolutional neural networks.

Preferably, the data fusion step is additionally based on the output of the scene audio artificial neural network.

Optionally, the method further comprises the step of storing the behaviour data as training data. Optionally the method further comprises the step of storing the user perspective data as training data. Optionally, the method further comprises the step of storing the scene audio data as training data. Preferably the method further comprises the steps updating the preceding artificial neural networks based on the stored training data, transmitting data indicative of the updated artificial neural networks to a centralised server, and receiving data indicative of a global machine learning model to update the artificial neural networks with.

Advantageously, storing data for training later enables the electronic device to not consume any extra CPU cycles and thus leaving the appropriate processing power for the current task at hand. Later, when the electronic device is not under active load, the training steps can occur. Thus the delaying of training provides a form of load balancing which in turn leads to improved processing as the operating system does not need to constantly switch contexts between training and running the application.

Preferably, the method further comprises receiving a plurality of transmissions comprising data indicative of updated neural networks, updating the global machine learning model based on the plurality of updated neural networks received, and providing data indicative of the global machine learning model to devices conducting inference using the global machine learning model. Preferably, these method steps are conducted on a centralised server.

Advantageously, federated learning provides a way to preserve the privacy of the data obtained local to each electronic device such that said data remains only on said device. Further advantages include reduction in bandwidth to train a global model in that only the model updates are provided to the centralised server and not the complete data sets used to obtain the model updates.

Optionally, the method further comprises the step of receiving peripheral data, wherein the peripheral data is data indicative of the current state of a peripheral that is coupled to the electronic device. Preferably, the peripheral data comprises an indication of a type of the peripheral and an identifier of the peripheral. Preferably, the received peripheral data is compared with a list of known peripheral data, and wherein the detection of the behaviour pattern label and the indication to the likelihood of an anomaly occurring is further based on this comparison.

Advantageously, black listing and/or white listing, such as presented in the embodiment above, provides further indication as to the likelihood of an anomaly occurring in a computationally efficient manner. Comparison of peripheral data to received peripheral data can provide simple but effective notification of the presence of a disallowed (or conversely, allowed) peripheral.

Optionally, the method further comprises the step of recognising unexpected patterns based on the received behaviour data, wherein unexpected patterns include at least one or more of the following: too many inputs being provided at a given time, to location of the inputs being provided at a given time are too distal for a hand of the user, and the speed of inputs being too fast for the hand of the user.

Optionally, the method further comprises the step of identifying an unexpected pattern based on the received behaviour data, wherein the unexpected pattern indicates a sequence of the users inputs are beyond a physical limitation of the user. Preferably, the physical limitations include any one or more of the following: too many button presses at a given time, a series of button presses is too quick, and/or button presses which are physically impossible for a user.

Advantageously, the use of physical limitations of either a normal (i.e. not counterfeit or not modified) peripherals allows for the analysis to be constrained to identify only these specific instances. Constraint of the problem space enables more efficient data processing to occur as the anomalous behaviour being looked for is limited to only the above given types.

Preferably, the received behaviour data comprises gyroscope data from a peripheral associated with the electronic device and wherein the step of identifying the unexpected pattern is based on the gyroscope data. More preferably the step of identifying the unexpected pattern comprises identifying a button press that physically could not have occurred based on the gyroscope data. More preferably, the button press that physically could not have occurred based on the gyroscope data is indicative of a counterfeit or third party input device.

Similar to the advantages presented in the previous embodiment, constraining the determination of anomalies to specific physically (or perhaps non-physically) possible movements enables more efficient processing and thus more efficient identification of anomalous device operation.

Optionally, the behaviour pattern label and the behaviour pattern label hierarchies relate to a skilled of the user of the electronic device. Preferably, the behaviour pattern label hierarchies comprise beginner, intermediate, and expert. Optionally, the likelihood of an anomaly occurring relates to one of: anomaly, no anomaly, or suspicion of anomaly. Optionally, an anomaly is indicative of the user cheating at a game being played on the electronic device.

Also according to the first aspect, there is provided an electronic device comprising a processor configured to perform the method according to any of the previously described embodiments.

Also according to the first aspect, there is provided a computer program product comprising instructions which, when the program is executed by a computer, cause the computer to carry out the method according to any of the previously described embodiments.

Also according to the first aspect, there is provided a computer-readable storage medium comprising instructions which, when executed by a computer, cause the computer to carry out the method according to any of the previously described embodiments.

Also according to the first aspect, there is provided a system comprising an electronic device according to the previously described electronic device embodiment, and a training server configured to receive a model update from the electronic device.

Optionally, the training server is configured to receive multiple model updates from further electronic devices. Optionally, the training server is configured to conduct federated learning using at least the model update to generate a global model and provide the global model to the electronic device.

As set out above, federated learning provides a number of advantages relating to both privacy and efficiency of bandwidth.

The anomalous behaviour are preferably identified using a trained model. Such a trained model may be trained on images of the physical object. The trained model may deploy an artificial neural network (ANN). The ANN can be one of any number different architectures including a Feed Forward Network (FF), a Multilayer Perceptron (MLP) (which is an even more specific example architecture of an FF network), a Convolutional Neural Network (CNN), a Recurrent Neural Network (RNN), Long short-term memory (LSTM), an Autoencoder, or a Deep Belief Network. Other topologies and variations of the models listed above are also possible.

Different model types have different advantages and are best used for different purposes. For example as described herein, CNNs for video based inference/detection (as with the player's perspective) or CNNs for audio based inference/detection (as with the game audio), RNNs or LSTMs for player behaviour inference/detection, and FFs or MLPs to predict and categorise non-linear data.

ANNs can be hardware—(neurons are represented by physical components) or software-based (computer models) and can use a variety of topologies and learning algorithms.

ANNs usually have at least three layers that are interconnected. The first layer consists of input neurons. Those neurons send data on to the second layer, referred to a hidden layer which implements a function and which in turn sends the output neurons to the third layer. There may be a plurality of hidden layers in the ANN. With respect to the number of neurons in the input layer, this parameter is based on training data.

The second or hidden layer in a neural network implements one or more functions. For example, the function or functions may each compute a linear transformation or a classification of the previous layer or compute logical functions. For instance, considering that the input vector can be represented as x, the hidden layer functions as h and the output as y, then the ANN may be understood as implementing a function f using the second or hidden layer that maps from x to h and another function g that maps from h to y. So the hidden layer's activation is f(x) and the output of the network is g(f(x)).

A CNN usually comprises at least one convolutional layer where a feature map is generated by the application of a kernel matrix to an input image. This is followed by at least one pooling layer and a fully connected layer, which deploys a multilayer perceptron which comprises at least an input layer, at least one hidden layer and an output layer. The at least one hidden layer applies weights to the output of the pooling layer to determine an output prediction.

A RNN (of which LSTM can be considered a similar or related NN) comprises a similar architecture to a feed forward network, and additionally comprises connections between its nodes that create cycles such that nodes can affect their own input. Optionally, the RNN comprises forget gate(s).

ANNs (and the different architectures discussed above) may be trained using tagged and/or example data relating to the purpose the ANN is being used for (i.e. example cheating behaviour data is used to train for detecting cheating behaviour). The training may be implemented using feedforward and backpropagation techniques.

Some specific components and embodiments of the disclosed method are now described by way of illustration with reference to the accompanying drawings, in which like reference numerals refer to like features.

### BRIEF DESCRIPTION OF THE FIGURES

FIG. 1A depicts a data flow and associated method according to an example embodiment described herein comprising inputs, processing steps, and outputs.

FIG. 1B depicts a data flow and associated method according to a further example embodiment described herein comprising inputs, processing steps, and outputs.

FIG. 2 depicts a data flow and associated method according to yet another further example embodiment described herein showing inference and training.

FIG. 3 depicts a system diagram according to an example embodiment described herein.

FIG. 4 depicts a block diagram illustrating an example electronic device as described herein.

### DETAILED DESCRIPTION

The need for detecting anomalies occurring on an electronic device is necessary for a number of reasons. This can be a difficult task if the device is not under direct control, cannot be physically inspected, and/or be directly or visually monitored. This may be the case with electronic devices such as tools sold to an end user.

The example methods described herein may be particularly of use where the electronic device is a personal computer, and the entity wishing to monitor the personal computer wishes to ensure software on the device is not operating anomalously (and therefore triggering the device itself to operate anomalously). As used herein, anomalous operation preferably relates to an operating condition or status that the electronic device manufacturer or software developer of the software running on the electronic device does not wish the electronic device to exhibit.

A software developer (which has little or no control over the personal computer running a software product they are developing) may wish to ensure there is no third party software and/or third party peripherals which could interrupt or otherwise interact with the software product they have developed. It is very unlikely that this software developer has any control over the personal computer, nor can they inspect all of the code running on and peripherals operating and interacting with the personal computer. Thus, the software developer is limited to detecting anomalous operation of the software product (and therefore the personal computer) largely through the boundaries of the software product itself: in other words, detecting anomalous operation through inspection of inputs and outputs associated with their own software product.

These inputs and outputs can be processed “live” at the time the software product is under operation and running on the same electronic device the software product is. They additionally or alternatively can be recorded and analysed on the electronic device at a later date (delaying this processing can be advantageous in that it will not consume processing time when the electronic device is being under active use by the user). They can be recoded and sent to a secondary device to analyse (advantageously also not interfering with the processing time on the electronic device while it is being actively used).

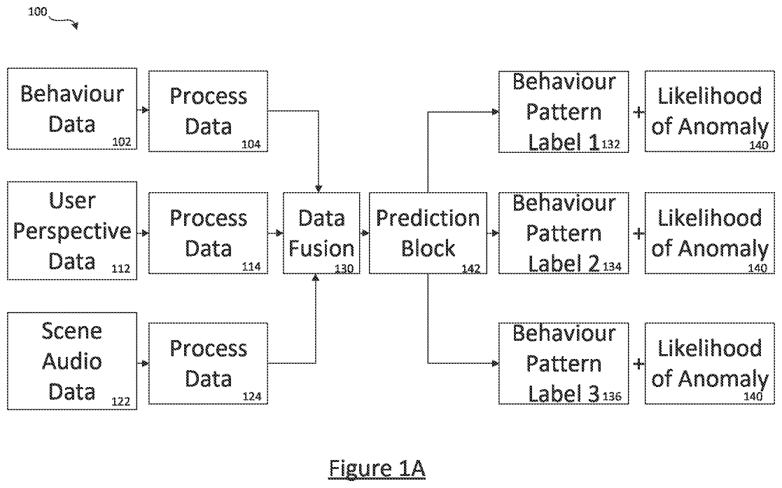

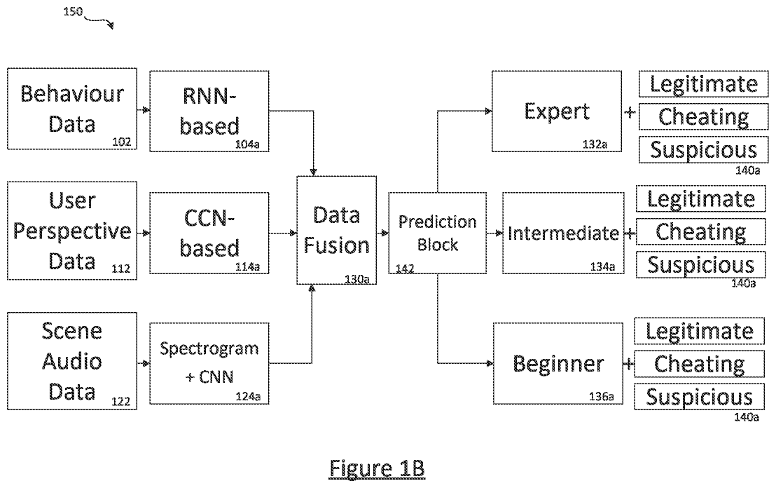

Referring to FIG. 1A, an example embodiment data flow 100 is shown. The data flow is also indicative of method steps associated with each data block. The data flow shows data reception steps 102, 112, 122, data processing steps 104, 114, 124, 130, and provision of output data steps 132, 134, 136, 140. The example data flow can be considered an example anomaly detection model. Not all of the data being shown as an input here is required. Preferably, the reception of data, processing of data, and outputting of data is conducted on an electronic device that is under inspection. Optionally, the steps are conducted on a separate device. This example data flow shows a number of method steps of an associated method. For example, the input data is analogous to a method step of receiving input data.

Preferably, the behaviour data 102 comprises an indication of the input of a user operating the electronic device. Preferably, the behaviour data indicates the buttons pressed and the length of time they are pressed. For example, where a PlayStation™ controller is used for input, behaviour data represents the following sort of information: user pressed R2 for 2.2 seconds, then moved the left analogue stick up for 1 second, then released R2, etc.

In a first step, the behaviour data 102 is received. This data is then processed 104 and optionally provided into a data fusion step 130.

Optionally, the user perspective data 112 and scene audio data 122 belong to the general concept of “scene information”. Scene information represents the output of the electronic device that a legitimate (i.e. non-anomalous operating or non-cheating) user/device would have access to. That is to say, it represents the unmodified output and/or the output the electronic device and/or the software running on the electronic device is outputting (or trying to output). This scene information is the only information a user that is not cheating is presented and thus any decisions a user makes or behaviour a user exhibits (through their behaviour data) during the game (where non-anomalous electronic device operation is occurring) should only be based on this information.

Preferably, the user perspective data 112 comprises an indication of the visual components of a scene being displayed on the electronic device. This can also be considered the visual output of the software currently being run.

Preferably, the scene audio data 112 comprises an indication of the audio components of a scene being presented on the electronic device. This can also be considered the audio output of the software currently being run.

Of note, all of the behaviour data and scene information are time-based or have a time related component. Thus, correlations can be made between data points that occur concurrently or within a short period of time of each other. Optionally, the data reception steps 102, 112, 122 and/or processing steps 104, 114, 124 are conducted substantially in parallel and/or lock step such that the data fusion module 130 is able process all of the scene data and behaviour data that occurred at a given time. Alternatively or additionally, the data fusion module is configured to correlate input data (processed behaviour data, processed user perspective data, and/or scene audio data) by the time they occur. Alternatively or additionally, the data fusion step comprises an associated temporary storage or buffer to accommodate the inputs to the data fusion step arriving out of sync with each other. By conducting data fusion in this time correlated or time lock stepped manner, it may be possible to identify that a user is reacting to (which would be represented in the behaviour data) information that is not actually available to them (which would be represented in the scene information).

An example use of the time-correlated processing in the context of a first person shooter game is now provided. If a user is moving their aim to another in-game character when the other in-game character that is not actually in view (such data is not present in the user perspective data) and the user cannot hear them to locate them (such data is not present in the scene audio data), then this likely indicates that the device is operating anomalously. Indication that a user is aiming at something can be identified using the behaviour data. Such an analysis requires that both the behaviour data and the scene data being inputted to the data fusion step relate to the same time period. That is to say, the behaviour that occurred at a time period T1 to T2 needs to be analysed with same scene data that occurred at the time period T1 to T2 for such an analysis to occur.

If only the user behaviour data is provided, then no data fusion occurs. The user behaviour data is passed to the prediction block 142. If more than one data source is provided, then data fusion does occur, and the output of the data fusion step is passed to the prediction block. The prediction block is configured to provide an output that is indicative of both a behaviour pattern label 132, 134, 136 and a likelihood of an anomaly 140.

The output data of the example embodiment comprises two main components: behaviour pattern label 132, 134, 136 and a likelihood of an anomaly 140. The behaviour pattern labels belong to a hierarchy of behaviour pattern labels. The behaviour pattern labels identify an overall different behaviour of potential different users. For example, the behaviour pattern labels could represent users that:
use a keyboard, use a mouse, or use a controller;
are a beginner user of a tool/electronic device, or are an experienced user of the tool/electronic device;
are a beginner player, an intermediate player, or expert player in the context of a computer game.

It can be seen that some of the behaviour pattern labels relate to each other in a hierarchical manner (i.e. the behaviour between a beginner and intermediate user are similar and/or belong to broad category of data, however the intermediate user might be able to conduct more actions per minute than a beginner).

By determining which hierarchy label a user is operating within, anomalous behaviour associated with that hierarchy label can more easily be identified. And with identification of anomalous behaviour, inferences can be made as to whether the device itself (and/or a peripheral associated with the device) is operating anomalously. For example, where a user is considered a beginner user of the electronic device and/or software running on the electronic device, only certain input patterns are to be expected. Where the user displays input patterns that are not normally associated with their hierarchy label (i.e. the behaviour could be considered anomalous), this could be an indication that the electronic device is operating anomalously. These input patterns could be actions per minute, the ability for the user to operate a peripheral (such as a mouse or analogue stick) at a given speed and/or with a given accuracy, and/or the user's ability in moving a cursor (through use of a peripheral such as a mouse of analogue stick) to a particular location (such as at another in-game character).

For example, the method described herein labels a user as a beginner in the context of a particular first person shooter (which may be identified though their movement ability or other behavioural inputs). Were the behaviour data to indicate that the user was aiming their cursor at an opposing in-game character and land on their head (a critical and advantageous zone to aim in the context of first person shooters) too quickly and too accurately—perhaps at the level a professional player might do—this strongly suggests that there is some kind of aim-bot installed on the electronic device and therefore the electronic device is operating anomalously.

Advantageously, this specific tagging and identification of data then subsequent correlation of hierarchy label and patterns associated with that hierarchy label allows inferences to be made about the operation of the electronic device itself without any monitoring of the electronic device itself—only the input(s) and optionally output(s) are required. Thus an understanding of the internal operation of the software running on the electronic device is understood through viewing only the input(s) and optionally output(s) provided to the electronic device. As will be described further, this system can also be improved to detect further anomalous behaviour through use of scene information.

Where user perspective data 112 is received, this too is processed 114. Preferably the user perspective data is processed such that feature extraction is conducted. This feature extraction is conducted such that reduction in the dimensionality of the user perspective data received is achieved. User perspective data is usually image and/or video data. The output of the user perspective data processing step is preferably a vector for a single image or a sequence of vectors for a video. Preferably processing of this image or video data additionally comprises normalisation on the three RGB channels and/or resizing.

Where scene audio data 122 is received, this too is processed 124. Preferably the scene audio data is processed similarly to that of the user perspective data in that the dimensionality of the received data is reduced.

As mentioned above, where multiple data sources are received 102, 112, 122 and processed 104, 114, 124, a data fusion step 130 is conducted. The data fusion step takes the output of the processed data and conducts data fusion. As mentioned above, this data fusion step preferably correlates different processed data sources 104, 114, 124 according to the time the received data occurred. The data fusion step then provides its output to a projection block 142. This projection block provides an output that indicates the behaviour pattern and/or a likelihood of an anomaly occurring.

Referring to FIG. 1B, an example embodiment data flow 150 is shown. Similarly, the example embodiment data flow is or is implemented by a method. The data flow and/or method can be considered as an implementation of an anomaly detection model. The same or similar reference numerals between the data flow 100 of FIG. 1A and FIG. 1B have been used to show the same or similar data and/or processing steps. The anomaly detection model described with reference comprises a number of artificial neural networks and can be considered a machine learning model and/or comprising a number of machine learning models. The process described in FIG. 1B is the inference aspect(s) of the machine learning model. Training is described in greater detail below.

The behaviour data 102 is preferably processed 104a by an ANN-based machine learning model. Thus this ANN-based machine learning model can be described as a behaviour data ANN-based machine learning model and/or it comprises a behaviour data ANN. Preferably, the behaviour data ANN is RNN-based.

The user perspective data 112 is preferably processed 114a by an ANN-based machine learning model. Thus this ANN-based machine learning model can be described as a user perspective ANN-based machine learning model and/or it comprises a user perspective ANN. Preferably, the user perspective ANN is CNN-based. Preferably, normalisation and/or resizing are conducted as a part of the processing and before being inputted in the NN.

The scene audio data 122 is processed first to produce a time-frequency representation of the audio data. Preferably the time-frequency representation is a spectrogram. Then, the time-frequency representation is processed by an ANN-based machine learning model. Thus this ANN-based machine learning model can be described as a scene audio ANN-based machine learning model and/or it comprises a scene audio ANN. Preferably, the scene audio ANN is CNN-based.

Where more than one data source 102, 112, 122 is received and processed 104a, 114a, 124a, a data fusion processing 130a step is conducted. This data fusion processing step is conducted using an ANN-based machine learning model. Thus this ANN-based machine learning model can be described as a data fusion ANN-based machine learning model and/or it comprises a data fusion ANN.

Preferably, the projection block 142 operates in a multiheaded hierarchical prediction manner. Preferably the projection block is an MLP. The multiheaded hierarchical prediction architecture enables the ANN to provide two types of outputs. In other words, the ANN jointly predicts the hierarchical behaviour label and the corresponding class of behaviour (where the class of behaviour provides or is the indication that an anomaly is occurring). As shown in the example of FIG. 1B, the MLP provides a hierarchical behaviour pattern label 132a, 134a, 136a and a likelihood of an anomaly occurring 140a associated at a given hierarchical behaviour pattern. Advantageously, designing the system as such allows for identification of anomalous behaviour based on (or at least associated with) the behaviour pattern label. Where the behaviour pattern label is a skill level of the user of the electronic device, this enables the method to separate what might be considered anomalous (or cheating) behaviour for a beginner from expert play patterns that an expert gamer exhibits.

In addition to the above described behaviour data processing 104, 104a of FIGS. 1A and 1B, further unexpected pattern recognition can be conducted. This further unexpected pattern recognition is based on the received behavioural data. In this further unexpected pattern recognition step, patterns are recognised based on the sequence and/or number of inputs provided to the electronic device. In particular, patterns which are physically impossible to undertake are identified. Physically impossible patters could include any one or more of the following:
too many button presses at a given time—the user only has a limited number of digits on their hand thus having, for example, more than 6 buttons pressed simultaneously and/or within close succession could indicate the peripheral they are using is a counterfeit and/or cheating one which provides additional button presses;
a series of button presses was too quick—the user and/or the peripheral used has physical limits as to how fast buttons can be pressed. Pressing a button too many times across a given period of time could indicate the peripheral they are using is a counterfeit and/or cheating one which provides enhanced button pressing speed; and
simultaneous button presses which are physically impossible—the buttons a user has access to given their hand position are limited. If button presses are present in the behaviour data (from the peripheral) which a user could not normally reach given what other buttons are currently being pressed, this could indicate the peripheral they are using is a counterfeit and/or cheating peripheral.

This detection is optionally augmented by the hierarchical behaviour pattern label. That is to say, the ability for a user to press buttons at given speeds will at least in part be affected by their own skill level—expert players likely can press buttons quicker than beginner. Further, expert players may use the controller in different more advanced ways to enable them to press more buttons concurrently. Expert players may for example use a “claw grip” which enables access to the circle, square, triangle and cross buttons while at the same time using R3 and the triggers R1 and/or R2.

This detection additionally can be enhanced through use of other sensors data from the peripheral. Optionally, where the peripheral provides gyroscope data, the gyroscope data could be used in combination with the unexpected pattern identification above. A gyroscope is able to detect subtle changes in the orientation of the peripheral. For example, under uses of a normal (non-counterfeit) peripheral, gyroscope data could highlight when a user reaches for R3 on their PlayStation™ controller. This is because when reaching for R3, the user is often required to shift the controller, even if subtly. Thus, if R3 is pressed (as represented in the behaviour data) and there is no corresponding appropriate gyroscope data to go along with the R3 button press, this would provide an indication of anomalous behaviour. This suspected anomalous behaviour is provided to the data fusion step similar to the other data to assist in providing a final likelihood of anomalous behaviour.

Gyroscope data could similarly be used in coordination with detecting button presses on normal (non-counterfeit) peripheral. The action of pressing a button would slightly adjust the orientation of the peripheral which would be represented in gyroscope data. In particular where multiple quick button presses are being detected, if no corresponding gyroscope information is found, then this could be an indication that there is anomalous behaviour and/or they are using a counterfeit behaviour. This information would be provided to the data fusion step similar to the processed behaviour and scene data to assist in providing a final likelihood of anomalous behaviour.

Where there is a suspicion of anomalous operation of the electronic device, the pattern and any other sundry data such as scene data is preferably stored and analysed later by other existing methods for anomaly detection. Optionally, this additional anomaly detection step is conducted on a device other than the electronic device in case the electronic device has been tampered with in case such that further anomaly detection does not operate correctly.

Additionally, peripheral type and id checks can be conducted on the peripheral device to try to detect anomalous and/or counterfeit peripherals being used. This additional check could include looking up any of the controller ID, serial number, model number, number of configurable or useable inputs on the peripheral. Any one or more of these data points from the peripheral are compared with a list of acceptable and/or approved peripheral device numbers such that a white list of, for example, controller IDs, is used. Additionally or alternatively, a blacklist of known bad values may be used.

The above described example data flows 100, 150 and associated data processing methods comprise a number of machine learning and in particular ANNs. In order to achieve appropriate identification of both behaviour pattern label and an indication to the likelihood of an anomaly occurring through use of ANNs, training of the ANNs is conducted prior to their use. The ANNs are obtained prior to any inference is conducted. Preferably the ANNs are obtained from a centralised federated learning system.

In an initial training stage to train and generate the initial ANNs, training is conducted in an unsupervised manner and the training is designed to recognise a hierarchical behaviour pattern. The unsupervised training data is preferably a large dataset collected over across a large number of users of the electronic device and other electronic devices of the same or similar type. Unsupervised learning is particular advantageous as performing labelling on the large data set would be particularly demanding in terms of resources. Unsupervised learning is optionally used here to filter down the collected dataset and remove examples that are not relevant or are clearly common behaviour from among players across different hierarchical behaviour patterns (and therefore the data is not useful in differentiating different behaviour into the different labels).

After this initial unsupervised training stage, the hierarchical behaviour pattern is validated using a high-quality dataset. High-quality here refers to data that is known to be accurately tagged with regards to hierarchical behaviour patterns.

Optionally the same or similar process is used for the likelihood of an anomaly occurring output of the machine learning model(s). Optionally the training for the likelihood of an anomaly occurring occurs after the training for the hierarchical behaviour pattern training.

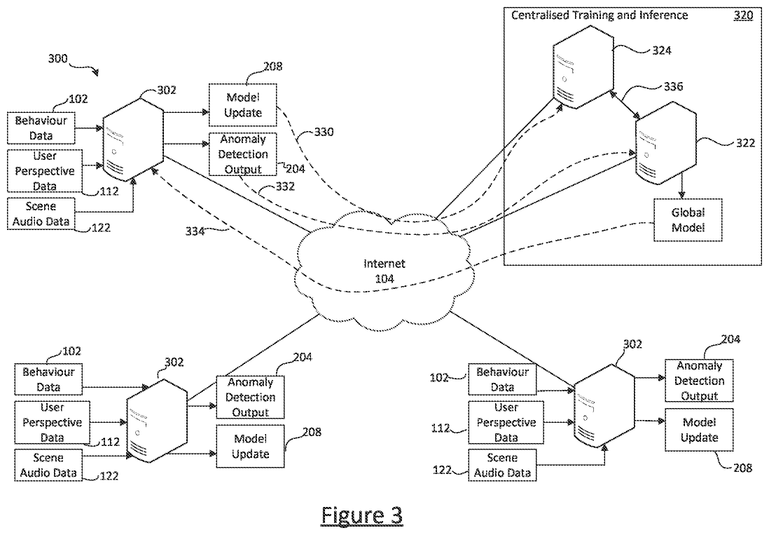

As mentioned, preferably the anomaly detection is conducted on the electronic device where anomalous behaviour may occur. Optionally, the electronic device receives fully trained ANNs (trained according to the method as described in the preceding three paragraphs). As will be discussed below, preferably, each electronic device conducts further training (optionally called “updating” because the local model(s) is/are being updated) periodically and/or continually and the trained models are provided to a centralised training and interface system or server 320 (discussed in greater detail in FIG. 3) which coordinates centralised federated learning (across multiple electronic devices conducting a similar method as descried here). The centralised federated learning system then provides trained and updated models to the electronic device.

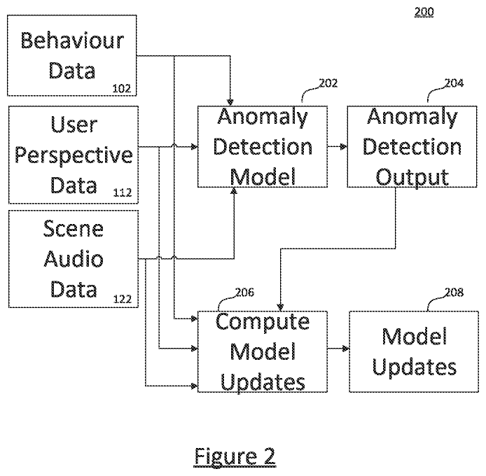

Referring to FIG. 2, an example inference and training data flow and/or method 200 is shown. This example embodiment comprises an anomaly detection model 202 which is preferably the anomaly detection model of FIG. 1A or FIG. 1B. The anomaly detection model therefore comprises data reception steps, processing steps, and data output (or inference output) steps.

The anomaly detection model provides an anomaly detection output 204. Preferably, the anomaly detection output comprises a behaviour pattern label and an indication to the likelihood of an anomaly occurring (as suggested in the examples of FIGS. 1A and 1B).

Also shown is the step of computing model updates 206. Computing model updates preferably takes the behaviour data 102 and the anomaly detection output 204 as inputs. Optionally, it also takes the user perspective data and/or scene audio data as an input. Model updates 208 are an output of the computing model updates step.

Computing model updates is preferably conducted using all data available. Preferably, this is the data that is collected locally on the electronic device itself. Thus, the electronic device updates a model which is based on the behaviours and scene information of the usage of the electronic device by an individual user (or select group of users if the devices is used by a few users). Preferably, computing the model update uses stochastic gradient descent.

Where the electronic device is configured to allow multiple different applications to be operated, there too will be different scenes and behaviours used for each different application. Preferably, different models are trained per application and/or per-scene type operating on the electronic device. For example, where the electronic device is a PlayStation™, the different applications are the different games a user might play on the PlayStation™. Many games will have different scenes and different behaviour patterns associated with them. Here, different models are trained per-game where appropriate.

Some models will not need to be different per-game. An example of this would be the models configured to conduct the further unexpected pattern recognition relating to physical limitations of the user. The user and/or peripheral will not change their physical limitations depending on the game being played—these are inherent to the user/peripheral.

The gyroscope-based detection discussed above uses ANN(s) which are (or have been) trained using appropriate training data which has been tagged and correctly correlated with button presses of the behaviour data 102.

Referring to FIG. 3, a diagram illustrating a system 300 comprising multiple electronic devices 302 conducting inference and training (as discussed with reference to FIG. 2) and a centralised training and inference system 320 is shown. All of the electronic devices are operatively coupled to the centralised training and inference system 320 via the Internet 104 or other appropriate network.

The data flows from some of the electronic devices 302 have been elided to help readability of the system diagram. While FIG. 3 only shows one electronic device in direct communication with the centralised training and inference server 320, it will be appreciated that any electronic device configured according to any of the preceding example embodiments as set out in FIGS. 1A, 1B, and/or 2 will similarly be able to communicate with the centralised training and inference server.

The centralised training and inference system 320 preferably comprises two servers: the centralised inference server 322 and the centralised training server 324. Alternatively the centralised training and inference system is implemented on one server performing both inference and training or a collection of microservices each performing one or both of the inference and/or training.

The centralised inference server 322 receives 332 the anomaly detection outputs from the electronic devices 302. Preferably, this is for the purpose of collecting information per-device and/or per-game about instances of anomalous behaviour. With this information, trends over time can be drawn about the operation of the electronic device to improve the determination that particular anomalous behaviour is occurring with an electronic device and/or game. For example, a one-off determination that anomalous behaviour is occurring with an electronic device may not necessarily mean that anomalous behaviour is actually occurring. However, multiple data points occurring frequently may suggest anomalous behaviour is occurring. Optionally, where anomalous behaviour, or suspected anomalous behaviour is detected, the behaviour data and scene information are provided to the central inference server such that it can conduct further analysis.

The centralised training server 324 receives 330 the model updates from the electronic devices 302. Upon reception of one or multiple model updates, the training server conducts a federated learning to generate a global model. The centralised training server 324 provides 336 the global model to the centralised inference server 322. This global model is then provided to each of the electronic devices 302. The electronic devices obtain 334 the global model from either the centralised inference server 322 or the centralised training server. This process can be considered centralised federated learning.

Advantageously, this federated learning ensures that any privacy sensitive material that might be part of the behaviour data 102, user perspective data 112, and/or scene audio data 122 remain local to the electronic device 302 and are not shared with any other devices. This is due to the fact that taking a trained or updated model and reversing the learning process to obtain the input training data is a near impossible task given the abstract nature of the ANNs and other machine learning steps and processes involved.

Advantageously, federated learning reduces the amount of data that is needed to be transferred to the centralised inference server 324. The same or at least similar learning outcomes can be achieved by distributing the learning on the electronic devices 302 and transmitting only the models themselves instead of transmitting all of the behaviour data 102, user perspective data 112, and/or scene audio data 122 to the server. This therefore makes better use of the electronic device's bandwidth capabilities.

A skilled person will appreciate that while detection of cheating is the main example provided herein, other anomalous behaviour may also be detected using the same or similar methods and systems described herein. This could include virus detection or tampering detection (whether on the electronic device itself or on a peripheral associated with the electronic device).

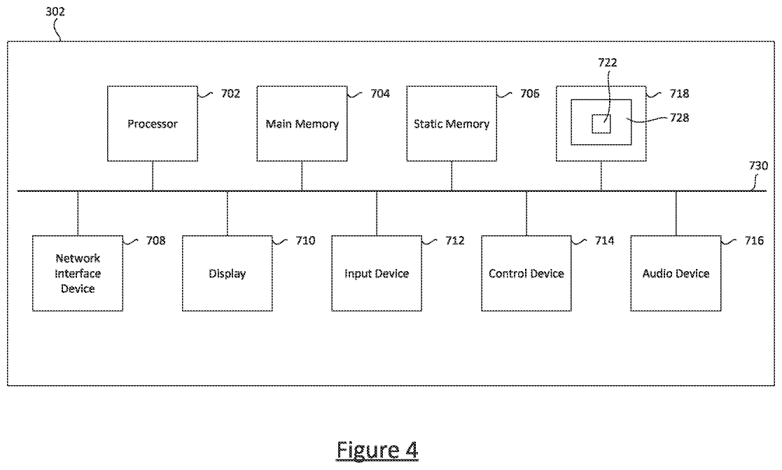

FIG. 4 illustrates a block diagram of one example implementation of a computing device 302 that can be used for implementing the data flow and/or method steps indicated in FIGS. 1A, 1B, and/or 2. The computing device is associated with executable instructions for causing the computing device to perform any one or more of the methodologies discussed herein. In alternative implementations, the computing device may be connected (e.g., networked) to other machines in a Local Area Network (LAN), an intranet, an extranet, a local wireless network, the Internet, or other appropriate network. The computing device may operate in the capacity of a server or a client machine (or both) in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a gaming device, a desktop computer, a laptop, a server, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 302 includes a processing device 702, a main memory 704 (e.g., read-only memory (ROM), flash memory, dynamic random-access memory (DRAM) such as synchronous DRAM (SDRAM) or Rambus DRAM (RDRAM), etc.), a static memory 706 (e.g., flash memory, static random-access memory (SRAM), etc.), and a secondary memory (e.g., a data storage device 718), which communicate with each other via a bus 730.

Processing device 702 represents one or more general-purpose processors such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute the processing logic (instructions 722) for performing the operations and steps discussed herein.

The computing device 302 may further include a network interface device 708. The computing device also may include a video display unit 710 (e.g., a liquid crystal display (LCD) or a cathode ray tube (CRT)), an alphanumeric input device 712 (e.g., a keyboard, touchscreen, or a game controller 122A, 122B), a cursor control device 714 (e.g., a mouse, touchscreen, or a game controller 122A, 122B), and an audio device 716 (e.g., a speaker). The video display unit optionally is a video display output unit. For example the video display unit is an HDMI connector. The video display unit preferably displays the user perspective data 112 as described throughout. The audio device optionally is an audio output unit. For example, the audio output unit is a stereo audio jack or coupled with the HDMI output. The audio unit preferably plays the scene audio data 122 as described throughout.

Preferably, the computing device 302 comprises a further interface configured to communicate with other devices, such as an extended reality display device. The further interface may be the network interface 708 as described above, or a different interface depending on the device being connected to. Preferably the interface configured to the extended reality device is such that a video stream from the extended reality display device can be provided to and from the computing device.

The data storage device 718 may include one or more machine-readable storage media (or more specifically one or more non-transitory computer-readable storage media) 728 on which is stored one or more sets of instructions 722 embodying any one or more of the methodologies or functions described herein. The instructions 722 may also reside, completely or at least partially, within the main memory 704 and/or within the processing device 702 during execution thereof by the computer system 104, the main memory 704 and the processing device 702 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” or “hardware module” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” or “hardware module” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “determining”, “providing”, “calculating”, “computing,” “identifying”, “combining”, “establishing”, “sending”, “receiving”, “storing”, “estimating”, “checking”, “obtaining” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

The singular reference of an element does not exclude the plural reference of such elements and vice-versa.

It is to be understood that the above description is intended to be illustrative, and not restrictive. Many other implementations will be apparent to those of skill in the art upon reading and understanding the above description. Although the disclosure has been described with reference to specific example implementations, it will be recognized that the disclosure is not limited to the implementations described but can be practiced with modification and alteration within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer implemented method for autonomous anomaly device operation detection, the method comprising the steps:
receiving behaviour data, wherein the behaviour data is indicative of a user's inputs to an electronic device,
determining a behaviour pattern label and an indication to the likelihood of an anomaly occurring based on the received behaviour data, wherein the behaviour pattern label belongs to behaviour pattern label hierarchy,
providing the behaviour pattern label and the likelihood of an anomaly occurring.

2. A method according to claim 1, wherein determining the behaviour pattern label and the indication to the likelihood of an anomaly occurring comprises:
processing the behaviour data using a behaviour machine learning model,
wherein the behaviour pattern label is based on the output of the behaviour machine learning model.

3. A method according to claim 2, wherein the behaviour machine learning model is an artificial neural network, optionally a recurrent neural network.

4. A method according to claim 2, further comprising the step of:
receiving user perspective data, wherein the user perspective data is indicative of a visual component of a scene being displayed by the electronic device, and wherein the step of determining the behaviour pattern label c and the indication to the likelihood of an anomaly occurring further comprises:
processing the user perspective data using a user perspective machine learning model, and wherein the behaviour pattern label and the indication to the likelihood of an anomaly occurring are additionally based on the output of the user perspective machine learning model.

5. A method according to claim 5, wherein the user perspective machine learning model is an artificial neural network, optionally a convolutional neural network.

6. A method according to claim 5, wherein the step of determining the behaviour pattern label and the indication to the likelihood of an anomaly occurring further comprises:
conducting data fusion based on the output of the user perspective machine learning model and the output of the behaviour machine learning model.

7. A method according to claim 6, wherein the data fusion step correlates the based on the output of the user perspective machine learning model and the output of the behaviour machine learning model with respect to time; and/or
wherein the data fusion step comprises providing the output of the user perspective machine learning model and the output of the behaviour machine learning model as inputs to a data fusion machine learning model.

8. A method according to claim 1, wherein the step of determining a behaviour pattern label and an indication to the likelihood of an anomaly occurring based on the received behaviour data comprises the use of a prediction machine learning model.

9. A method according to claim 8, wherein the prediction machine learning model is an artificial neural network, or a multi-headed hierarchical prediction model.

10. A method according to claim 2, further comprising the step of:
receiving scene audio data, wherein the scene audio data is indicative of audio being played in a scene being presented by the electronic device, and wherein the step of determining the behaviour pattern label comprises and the indication to the likelihood of an anomaly occurring further comprises:
processing the scene audio data using a scene audio machine learning model, and wherein the behaviour pattern label and the indication to the likelihood of an anomaly occurring are additionally based on the output of scene audio artificial neural network.

11. A method according to claim 10, where the received scene audio data is processed to produce a time-frequency representation of the audio.

12. A method according claim 10, wherein the data fusion step is additionally based on the output of the scene audio machine learning model.

13. A method according to claim 1, further comprising the step of:
storing the behaviour data as training data;
updating the artificial neural networks based on the stored training data,
transmitting data indicative of the updated artificial neural networks to a centralised training server, and
receiving data indicative of a global machine learning model to update the artificial neural networks with.

14. A method according to claim 4, further comprising the step of:
storing the user perspective data as training data;
updating the artificial neural networks based on the stored training data,
transmitting data indicative of the updated artificial neural networks to a centralised training server, and
receiving data indicative of a global machine learning model to update the artificial neural networks with.

15. A method according to claim 10, further comprising the step of:
storing the scene audio data as training data;
updating the artificial neural networks based on the stored training data,
transmitting data indicative of the updated artificial neural networks to a centralised training server, and
receiving data indicative of a global machine learning model to update the artificial neural networks with.

16. A method according to claim 1, further comprising the step of:
receiving peripheral data, wherein the peripheral data is data indicative of the current state of a peripheral that is coupled to the electronic device.

17. A method according to claim 16, wherein the peripheral data comprises an indication of a type of the peripheral and an identifier of the peripheral; and/or
wherein the received peripheral data is compared with a list of known peripheral data, and wherein the detection of the behaviour pattern label and the indication to the likelihood of an anomaly occurring is further based on this comparison.

18. A method according to claim 1, further comprising the step of:
recognising unexpected patterns based on the received behaviour data, wherein unexpected patterns include at least one or more of the following: too many inputs being provided at a given time, to location of the inputs being provided at a given time are too distal for a hand of the user, and the speed of inputs being too fast for the hand of the user.

19. A method according to claim 1, further comprising the step of:
identifying an unexpected pattern based on the received behaviour data, wherein the unexpected pattern indicates a sequence of the users inputs are beyond a physical limitation of the user.

20. A method according to claim 19, wherein the physical limitations include any one or more of the following:
too many button presses at a given time,
a series of button presses is too quick, and/or
button presses which are physically impossible for a user.

21. A method according to claim 19, wherein the received behaviour data comprises gyroscope data from a peripheral associated with the electronic device and wherein the step of identifying the unexpected pattern is based on the gyroscope data.

22. A method according to claim 21, wherein the step of identifying the unexpected pattern comprises identifying a button press that physically could not have occurred based on the gyroscope data, optionally
wherein the button press that physically could not have occurred based on the gyroscope data is indicative of a counterfeit or third party input device.

23. A method according to claim 1, wherein the behaviour pattern label and the behaviour pattern label hierarchies relate to a skill of the user of the electronic device.

24. A method according to 23, wherein the behaviour pattern label hierarchies comprise beginner, intermediate, and expert.

25. A method according to claim 1, wherein an anomaly is indicative of the user cheating at a game being played on the electronic device.

26. An electronic device comprising a processor configured to perform the method according to claim 1.

27. A non-transitory computer-readable storage medium comprising instructions which, when executed by a computer, cause the computer to carry out the method according to claim 1.

28. A system comprising:
an electronic device according to claim 26, and
a training server configured to receive a model update from the electronic device.

29. The system according to claim 28, wherein the training server is configured to receive multiple model updates from further electronic devices; and/or
wherein the training server is configured to conduct federated learning using at least the model update to generate a global model, and provide the global model to the electronic device.
